(19) United States
(12) Patent Application Publication
(10) Pub. No.: US 2009/0015000 A1
(43) Pub. Date: Jan. 15, 2009

(54) Apparatus and method for identifying a container

(76) Inventor: Yvette F. Wolfe, Richmond, VA (US)

Correspondence Address: RYNDAK & SURI LLP, 200 W. MADISON STREET, SUITE 2100, CHICAGO, IL, 60606, US

(21) Appl. No.: 12/079,306

(22) Filed: Mar. 26, 2008

Related U.S. Application Data
(63) Continuation of application No. 60/920,501, filed on Mar. 28, 2007.

(51) Int. Cl. B42D 15/10; B65D 85/00; B42D 15/00

(52) U.S. Cl. 283/74; 206/459.5; 283/70

(57) ABSTRACT

A container identifying apparatus and method are provided for distinguishing easily confusable containers in social settings. In particular, an apparatus having a charm attached to a flexible band may be stretched around a beverage bottle neck or body, stretched around a beverage can tab, or wrapped around the handle of a beverage mug. The container identifying apparatus may also be beneficially used to identify containers other than beverage containers, such as lip balm containers, sunscreen containers, lotion containers, deodorant containers, snack containers, and any other container that may be confused with a similar container in a social situation.

### FIELD OF THE INVENTION

The present invention relates to container identifying members and methods of identifying containers and distinguishing containers from one another. More particularly, it relates to identifying members attached to a container neck, body or tab by an elastic ring.

### BACKGROUND OF THE INVENTION

Frequently at parties, meetings, gyms, family gatherings, amusement parks, school lunchrooms or playgrounds, sporting events and gatherings, around the house, or other business or social settings, there may be more than one person consuming beverages in very similar or identical containers, including glass or plastic bottles, mugs, cans, cups, glasses, juice boxes, or any other widely used beverage container. Currently, one has no satisfactory way to identify one's own container in such a situation. For example, it is common to loosely attach dangling ornaments to the stems of wine glasses to distinguish the glasses of guests at an elegant function such as a wedding or banquet. These ornaments are typically attached by connecting the loose ends of a relatively rigid ring around the stem of a glass. Such identifying apparatus and methods are wholly inadequate for a wide range of everyday, practical beverage containers, including those mentioned above, which lack a feature similar to a wine glass stem. A typical wine glass ornament would either attach insecurely or not at all to these containers, resulting in the ornament either falling off the container or obstructively and annoyingly dangling in the face of someone tilting the container to try to drink from it.

As a result, people drink from containers and bottles that are not their own, often resulting in the spread of germs between two or more people drinking from the same container. Alternatively, people throw away containers that are their own, for fear of contamination by others. A need therefore exists for a convenient, practical and appealing container identifying apparatus and a method of using it to distinguish beverage containers, thereby decreasing the transfer of germs, both among adults and among children, and saving money and resources by preventing people from needlessly throwing away half-full containers.

### BRIEF SUMMARY OF THE INVENTION

In accordance with one aspect of the present invention, an apparatus for identifying a container is provided. The apparatus has a band and an identifying member attached to the band. The band is adapted to fit securely around a part of the container, and the identifying member is substantially retained in a fixed position with respect to the band when the band is secured to the part of the container.

In one embodiment of the first aspect, the band is continuous and elastic. For example, the band may be made of silicone.

In another embodiment of the first aspect, the band has two free ends connected to each other by a fastener. The fastener may be a hook and loop fastener, a snap connector, or any other suitable fastener.

In another embodiment of the first aspect, the identifying member is glued to the band.

In another embodiment of the first aspect, the identifying member is attached to the band by a clip.

In another embodiment of the first aspect, the identifying member has an extending boss which pressure-fits through a hole in the band.

In another embodiment of the first aspect, the container is a beverage bottle. The band may fit around a neck of the bottle or a main portion of the bottle. The main portion of a bottle is termed the “body” herein.

In another embodiment of the first aspect, the container is a beverage can. In particular, the band may be adapted to fit around the tab of the can.

In another embodiment of the first aspect, the container is a juice box.

In another embodiment of the first aspect, the identifying member has a writing surface, on which a user may write indicia.

In a second aspect of the present invention, a method of identifying a container is provided. The method includes the steps of providing an apparatus according to the first aspect, and securing the apparatus to a part of a container.

In one embodiment of the second aspect, the identifying member of the apparatus provided has a writing surface, and the method further includes the step of writing indicia on the writing surface.

In a third aspect of the present invention, another method of identifying a container is provided. The method includes the steps of providing an apparatus comprising an identifying member attached to a flexible band in the form of a continuous loop, folding the band around a part of the container so that a U-shaped end of the continuous loop meets the identifying member, and inserting the identifying member through the U-shaped end to secure the apparatus to the part of the container.

### BRIEF DESCRIPTION OF THE DRAWINGS

FIG. 1 is a right side perspective view of a container identifying apparatus in accordance with the present invention having a soccer-ball charm 14a.

FIG. 2a is a front view of a container identifying apparatus of FIG. 1.

FIG. 2b is a front view of a container identifying apparatus in accordance with the present invention having a flower charm 14b.

FIG. 2c is a front view of a container identifying apparatus in accordance with the present invention having a sun charm 14c.

FIG. 2d is a front view of a container identifying apparatus in accordance with the present invention having an elephant charm 14d.

FIG. 2e is a front view of a container identifying apparatus in accordance with the present invention having a stop-sign charm 14e.

FIG. 2f is a front view of a container identifying apparatus in accordance with the present invention having a voice-bubble charm 14f.

FIG. 3 is an exploded perspective view of a container identifying apparatus in accordance with the present invention having a basketball charm 14g.

FIG. 4 is a front view of a container identifying apparatus in accordance with the present invention, with the charm shown in phantom view to illustrate the glue join 17 between charm 14 and backing 16.

FIG. 5 is a top view of a container identifying apparatus in accordance with the present invention.

FIG. 6a is a top view of an alternative embodiment of a container identifying apparatus in accordance with the present invention.

FIG. 6b is a perspective view of another embodiment of a container identifying apparatus in accordance with the present invention.

FIG. 6c is a perspective view of still another embodiment of a container identifying apparatus in accordance with the present invention.

FIG. 7a is a perspective view of yet another embodiment of a container identifying apparatus in accordance with the present invention.

FIG. 7b is a perspective view of still another embodiment of a container identifying apparatus in accordance with the present invention.

FIG. 8 is a front view of a beverage bottle bearing a container identifying apparatus in accordance with the present invention.

FIG. 9 is a front view of a beverage bottle bearing an alternative embodiment of a container identifying apparatus in accordance with the present invention.

FIG. 10 is a front view of a can bearing a container identifying apparatus in accordance with the present invention.

FIG. 11a is a left side perspective view of a mug bearing a container identifying apparatus in accordance with the present invention.

FIG. 11b is a right side perspective view of a mug bearing a container identifying apparatus in accordance with the present invention.

### DETAILED DESCRIPTION OF THE INVENTION

A convenient, practical and appealing container identifying apparatus and method of using it to identify and distinguish beverage containers are described in this section.

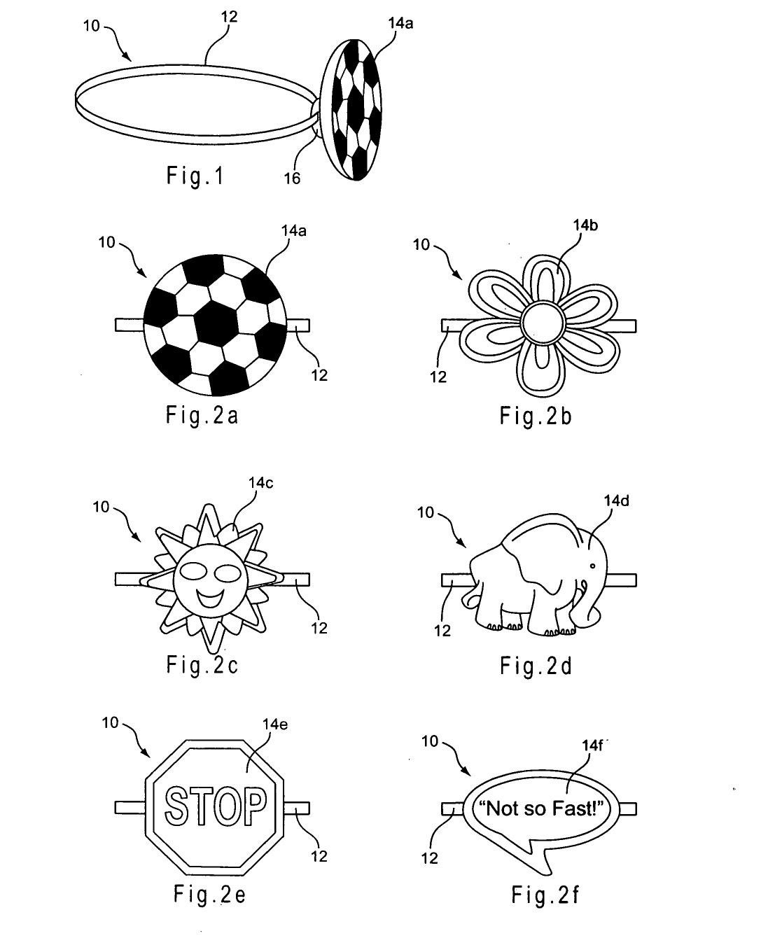

Referring to FIGS. 1-5, there is shown a closed-loop container identifying apparatus 10 in accordance with the present invention. Container identifying apparatus 10 is composed of a closed-loop flexible band 12 with an attached charm 14. As shown in FIG. 1, the band 12 may be threaded through a backing 16 which is attached to the back face of a charm 14a. In the example illustrated, charm 14a is a soccer ball charm. FIGS. 2a-f are front views of several examples of suitable charms that may be attached to band 12 in accordance with the present invention, namely, soccer ball charm 14a, flower charm 14b, sun charm 14c, elephant charm 14d, stop sign charm 14e, and voice bubble charm 14f. Turning to FIG. 2f, it should be noted that voice bubble charm 14f may be adapted so that any personalized phrase may be written on it to identify one's own beverage container, for example the phrase “Not so fast!” shown in the figure. It should also be noted that many other identifying members besides the charms 14a-f may be attached to band 12 within the scope and spirit of the present invention, including members depicting sports equipment, animals, nature images, signs or symbols other than those shown in the figures, flags, outlines of states or countries, team logos, popular cartoon characters, everyday objects, letters, numbers, or other types of indicia preferred by the user of a common container.

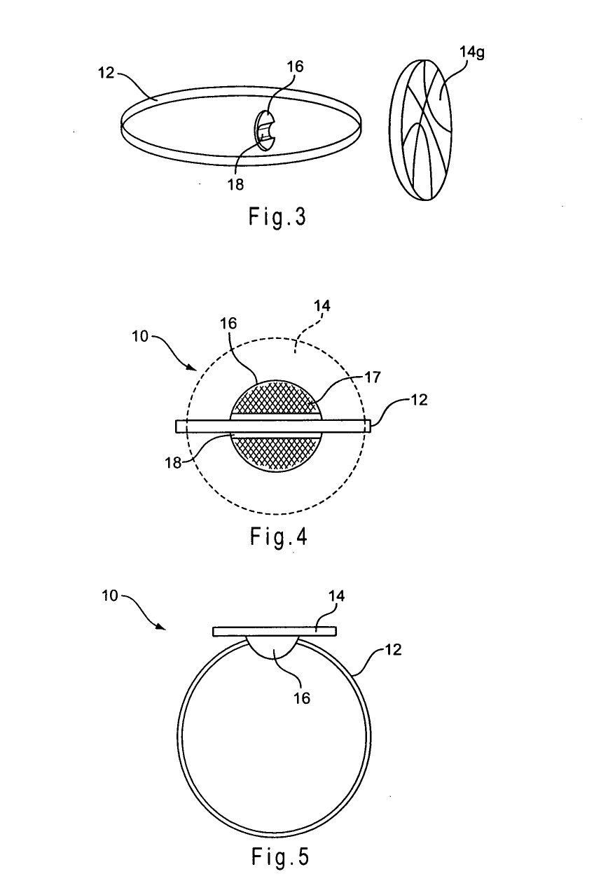

Turning to FIGS. 3-5, an example of how apparatus 10 may be assembled is shown. In FIG. 3, an exploded perspective view of container identifying apparatus 10 is shown. One manner of configuring apparatus 10 is thus illustrated, wherein backing 16 has an arch shape, so that backing 16 may be directly attached to the back of basketball charm 14g and band 12 of apparatus 10 threaded through arched channel 18. FIG. 4 is a front elevation view of apparatus 10 with charm 14 shown in phantom outline to reveal a glue join 17 and the spatial relationship of band 12 threaded through channel 18. FIG. 5 is a top elevation view of the apparatus 10, further clarifying the configuration of band 12, charm 14, and backing 16 illustrated in FIGS. 3 and 4.

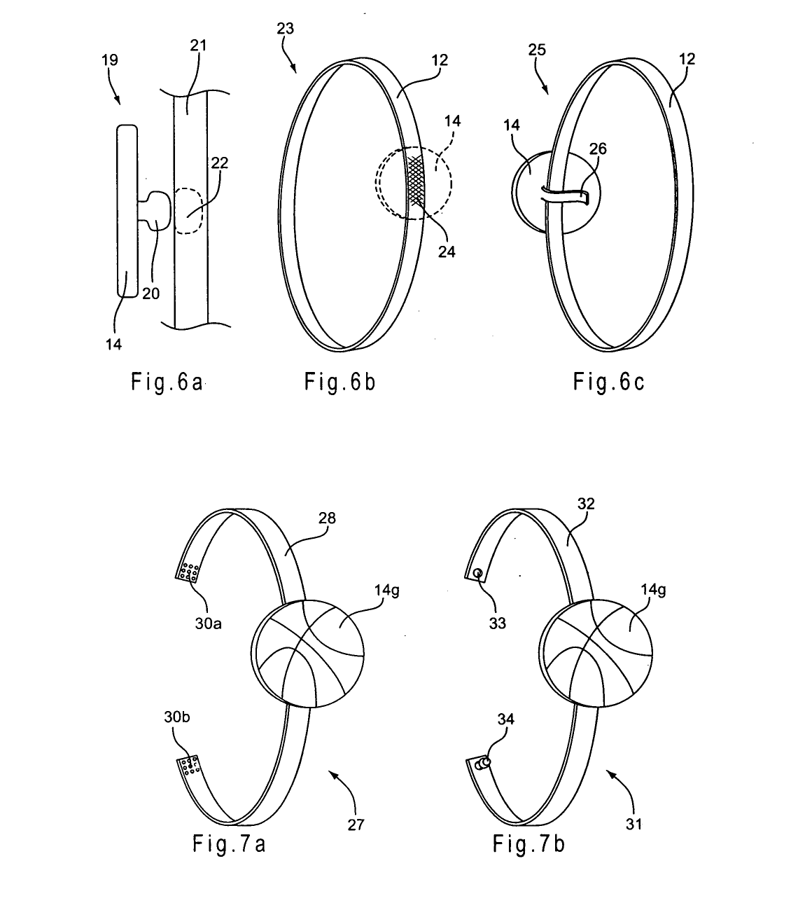

While the embodiment illustrated in FIGS. 1-5 has charm 14 attached to band 12 by threading band 12 through a backing 16, any suitable way of attaching an identifying member to a flexible band falls within the scope of the present invention. For example, charm 14 may have a post 20 that attaches to a band 21 having a hole 22 by a pressure fit or snap fit between post 20 and hole 22, as in container identifying apparatus 19 illustrated in FIG. 6a. In another example, charm 14 is directly glued to band 12 as in container identifying apparatus 23 illustrated in FIG. 6b, wherein charm 14 is shown in invisible phantom view to reveal glue join 24. In a third example, indicated as container identifying apparatus 25 in FIG. 6c, charm 14 is clipped onto band 12 by a clip 26. The examples shown in FIGS. 6a-c are by no means exhaustive. For instance, attaching charm 14 to a suitable band by means of mating a hook-and-loop fastener patch integral with charm 14 to one integral with the band or with a backing permanently connected to the band (not shown), or any other configuration in which charm 14 is held securely enough to the band to remain attached and still enough to avoid obstructing or annoying a user during use of the container, are also within the scope of the present invention. In the configurations of the foregoing examples and in other suitable configurations, the attachment of charm 14 to the band is preferably secure enough that charm 14 is substantially fixed with respect to the band when the container identifying apparatus is attached to the container.

Discontinuous flexible bands may also be substituted for closed-loop flexible band 12 within the scope and spirit of the present invention. For example, in FIG. 7a, a container identifying apparatus 27 is illustrated, wherein the loose ends of flexible band 28 having attached charm 14g may be connected by mating hook-and-loop fastener patches 30a and 30b. Turning to FIG. 7b, a container identifying apparatus 31 is illustrated, wherein the loose ends of flexible band 32 may be connected by securing snap hole 33 to snap post 34. Other suitable fasteners may also be used.

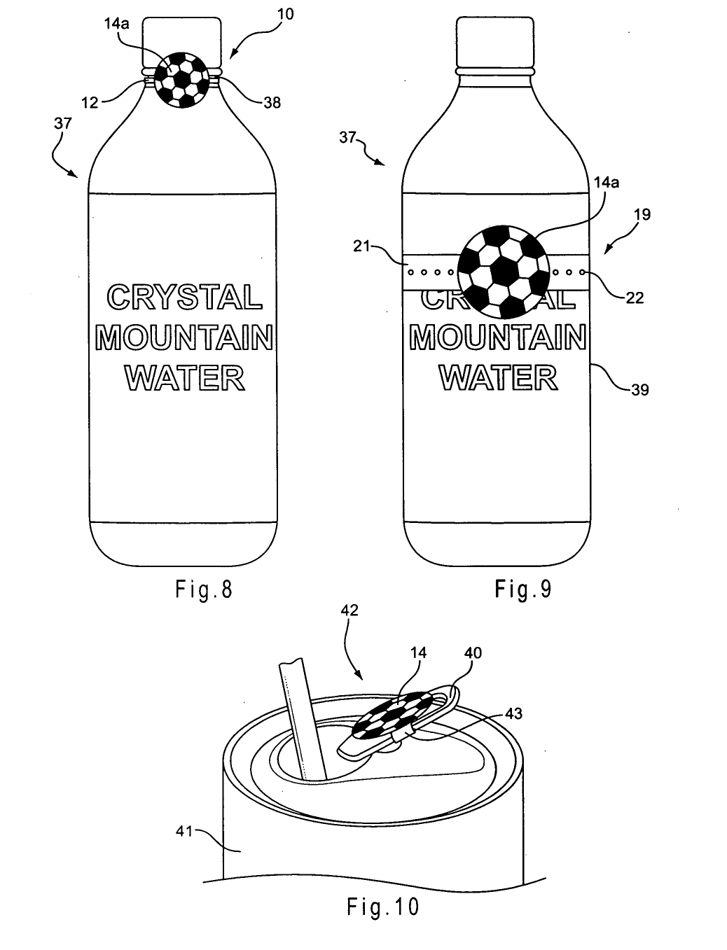

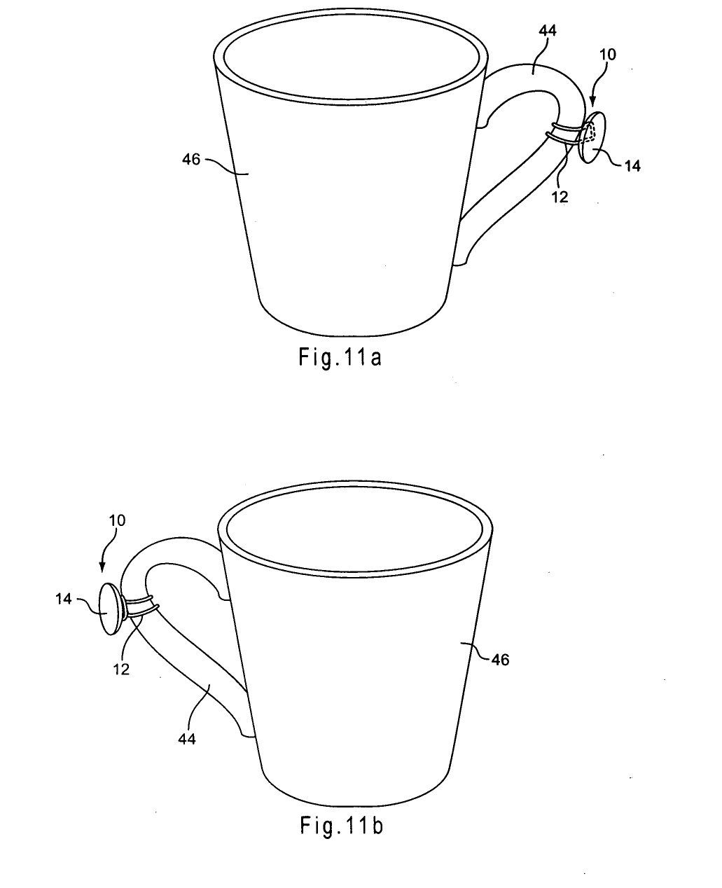

Any suitable beverage container may be identified by a container identifying apparatus according to the present invention. A few examples are shown in FIGS. 8-11b. In FIG. 8, a water bottle 37 is depicted, identified by attaching container identifying apparatus 10 to bottle neck 38. In FIG. 9, container identifying apparatus 19 is instead attached to body 39 of bottle 37. Although only a single soccer ball charm 14a is shown attached to band 21, it should be noted that where band 21 has a plurality of holes 22 as shown, a plurality of charms 14 having posts 20 as shown in FIG. 6a may be attached thereto. In a manner similar to that shown in FIG. 9, container identifying apparatus 19 could also be stretched around the body of a juice box. Tab 40 of a soda can 41 may be identified by a container identifying apparatus 42 composed of charm 14a attached to flexible band 43, as shown in FIG. 10. Container identifying apparatus 42 may have the elements and configuration of any illustrated embodiment of a container identifying apparatus described above, provided that band 43 is sized appropriately to fit securely onto Tab 40. Finally, container identifying apparatus 10 may be attached to a handle 44 of a coffee cup 46 by folding band 12 around handle 44 so that a U-shaped end of band 12 meets charm 14 and inserting charm 14 through the U-shaped end of band 12, to secure apparatus 10 to handle 44 in the manner shown in FIGS. 11a-b. This attachment configuration can also be used to attach apparatus 10 to the stem of a wine glass.

It is also within the scope of the present invention to use a container identifying apparatus of the invention on bottles other than water bottles or beer bottles, including baby bottles; or on beverage containers other than those mentioned above, including cups or flexible pouches. When the container is a bottle, the bottles most preferably have necks with a maximum outside diameter smaller than the maximum outside diameter of the bottle base. The bottles may be made of any suitable material, including glass and plastic. Bottle 39 is shown in the form of a water bottle in FIGS. 8-9 for purposes of illustration only.

Moreover, the container identifying apparatus may be beneficially used to identify containers other than beverage containers, including lip balm containers, sunscreen containers, lotion containers, deodorant containers, snack containers, and any other container that may be undesirably confused with a similar container in a social situation.

In the following paragraphs, the properties and function of elastic bands in accordance with the present invention will be discussed, generally with reference to band 12. The following discussion is equally applicable to bands 21, 28, 32 and 43, where not inconsistent with the above description and illustration of those bands, as well to any other suitable band within the scope of the present invention.

Band 12 has elasticity and memory so that it can be stretched to fit around a part of a container, and once so placed, tightly fits around the container so that it remains stable. In this regard, for example, conventional beverage bottles are typically formed with necks of varying lengths that taper outwardly from the top, open end towards the bottle base. With reference to FIG. 8, the inside diameter of band 12, when in its normal unstretched state, is preferably slightly smaller than the outside diameter of the smallest portion of neck 38 of bottle 37, so that when placed on neck 38, band 12 circumscribes neck 38 and is tightly wrapped around neck 38. However, it is within the scope of the present invention for the inside diameter of band 12, when in its normal unstretched state, to be the same as or slightly smaller than the outside diameter of any portion of a bottle neck, particularly in the case of a beer bottle, for example, which typically has a longer neck with a more gradual taper than that of neck 38, allowing band 12 to securely fit around a lower and larger portion of the bottle neck, without a strong tendency to slide upwards and become loose. For a container identifying apparatus adapted to fit on the body of a bottle, for example the apparatus 19 illustrated in FIG. 9, band 21 should similarly have an inside diameter that is preferably slightly smaller than the smallest outside diameter of body 39. Body 39 is shown in FIG. 9 to have a substantially uniform diameter. However, for a bottle having a tapered body, it is within the scope of the present invention for band 21 to have an inside diameter slightly smaller than any outside diameter of such tapered body.

The elasticity and memory of band 12 allows it to remain secure on a container when the container is tilted or inverted, such as during pouring or drinking of the contents of bottle 37, can 41, or mug 46. This may be accomplished by band 12 or other suitable band contracting from its stretched state about a suitable part of the container, including neck 38 or body 39 of bottle 37, or tab 40 of can 41. The contraction need not be complete to its original unstretched state; contraction to an intermediate state wherein the ring diameter is larger than the unstretched state but small enough to remain secure about the container feature when the container is tilted or inverted is sufficient and within the scope of the present invention. Alternatively, as described and illustrated above with reference to FIGS. 11a and b, where a container feature lacks a free end for direct insertion through band 12 but is small enough for band 12 to wrap twice around the feature, as in the example of mug handle 44, band 12 may be folded around the feature so that a U-shaped end of band 12 meets charm 14, and charm 14 may be inserted through the U-shaped end of band 12. In yet another alternative not shown in the figures, container identifying apparatus having loose ends, like apparatus 27 or 31, may be directly wrapped around a closed-loop or other relatively inaccessible feature of a container such as a mug handle, and the loose ends connected by hook-and-loop patches 30a-b, snap elements 33 and 34, or other suitable fasteners.

Preferably, band 12 is a circular O-ring, commercially available from numerous sources. Suitable ring materials include rubber (natural or synthetic), such as butadiene-styrene copolymers (SBR), acrylonitrilebutadiene copolymers, ethylenepropylene-diene rubbers (EPDM), butyl rubber, nitrile-butadiene rubber (NBR), chloroprene (Neoprene), silicone, urethane, polyacrylonitrile, tetrafluoroethylene fluorocarbon polymers (TEFLON®) and combinations thereof. Other suitable materials include metal and plastic. Preferably a material is chosen that is durable and that can be washed in a conventional automatic dishwasher without destroying the material or its properties.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. An apparatus for identifying a container, comprising
a band; and
an identifying member attached to the band,
wherein the band is adapted to fit securely around a part of the container, and
wherein the identifying member is substantially retained in a fixed position with respect to the band when the band is secured to the part of the container.

2. The apparatus of claim 1, wherein the band is continuous and elastic.

3. The apparatus of claim 2, wherein the band is made of silicone.

4. The apparatus of claim 1, wherein the band has two free ends connected to each other by a fastener.

5. The apparatus of claim 4, wherein the fastener is a hook and loop fastener.

6. The apparatus of claim 4, wherein the fastener is a snap connector.

7. The apparatus of claim 1, wherein the identifying member is glued to a backing member, and the band is threaded through the backing member.

8. The apparatus of claim 1, wherein the identifying member is glued to the band.

9. The apparatus of claim 1, wherein the identifying member is attached to the band by a clip.

10. The apparatus of claim 1, wherein the identifying member has an extending boss which pressure-fits through a hole in the band.

11. The apparatus of claim 1, wherein the identifying member is attached to the band by a hook-and-loop fastener.

12. The apparatus of claim 1, wherein the container is a beverage bottle.

13. The apparatus of claim 12, wherein the band is adapted to fit around a neck of the bottle.

14. The apparatus of claim 1, wherein the band is adapted to fit around a main portion of the container.

15. The apparatus of claim 1, wherein the band is adapted to fit around the tab of a beverage can.

16. The apparatus of claim 1, wherein the container is a juice box.

17. The apparatus of claim 1, wherein the identifying member has a writing surface on which a user may write indicia.

18. A method of identifying a container comprising
providing an apparatus comprising
a band, and
an identifying member attached to the band; and
stretching the band around a part of the container to secure the band to the part of the container,
wherein the identifying member is substantially retained in a fixed position with respect to the band when the band is secured to the part of the container.

19. The method of claim 18, wherein the providing an apparatus comprising an identifying member includes providing an apparatus comprising an identifying member having a writing surface, further comprising
writing indicia on the writing surface.

20. A method of identifying a container comprising
providing an apparatus comprising
an elastic band in the form of a continuous loop, and
an identifying member attached to the elastic band;
folding the band around a part of a container so that a U-shaped end of the continuous loop meets the identifying member; and
inserting the identifying member through the U-shaped end of the continuous loop to secure the apparatus to the part of the container and to retain the identifying member in a substantially fixed position with respect to the band and with respect to the part of the container.
